(19) United States
(12) Patent Application Publication
(10) Pub. No.: US 2010/0307332 A1
(43) Pub. Date: Dec. 9, 2010

(54) SUPERCHARGED ELECTROSTATIC AIR FILTRATION DEVICE

(76) Inventor: PETER SILTEX YUEN, SAN JOSE, CA (US)

Correspondence Address: Peter Siltex Yuen, 729 N White Road, San Jose, CA, 95127, US

(21) Appl. No.: 12/734,980

(22) PCT Filed: Dec. 10, 2007
(86) PCT No.: PCT/US07/86940

§ 371 Date: Jul. 23, 2010

(51) Int. Cl. B03C 3/68; B03C 3/017; A62B 7/10

(52) U.S. Cl. 95/26; 96/25; 95/57; 96/15; 96/55; 128/200.24

(57) ABSTRACT

A synchronized supercharge electrostatic field UV germicidal air filtration device is a high efficiency absolute air cleaner. It incorporates a dual function ionization system, electrostatic field filtration system UV light germicidal function within one system. This invention allows the physical size of air cleaning device to be substantially reduced while the absolute filtration efficiency is highly improved. This device provides a filtered and sterilized air output quality down to submicron size with quantifiable results; while it can be physically fit into an office partition wall. Secondly, both high voltage power supporting ionization and high voltage power supporting the electrostatic energy field are provided by one high voltage transforming circuit making it the most cost effective air filtration system.

### TECHNICAL FIELD

The present invention relates to airborne substances filtration with electronic air filtration system for air cleaning system; and a filtration device for both inhalation and exhalation breaths when this present invention is adopted to be used in respirator mask, hood and helmet.

The present invention relates to electronic air filtration with UV (ultraviolet) germicidal system, and more particularly, electrostatic field air filtration system.

### BACKGROUND ART

Currently, there are 3 types of electrical air filtration system that provide very low flow resistance to the moving air. They are ionic air filtration system, electrostatic air filtration system and electrostatic field air filtration system. Ionic filtration system cannot really be quantified even it does remove a large amount of airborne substances from air. Electrostatic air filtration system starts failing when the available surface area is covered by matters after being attracted to the electrostatic surface.

Electrostatic field air filtration process has been around for many years. It is one of the most efficient processes in removing airborne contaminants in the air and can also be quantified in the lab testing. Theoretically it works better than HEPA (high efficient pressurized air) filter filtration system. However, there are a few setback of electrostatic field air filtration system. Firstly, the system works better on charged airborne particles only. It does not work as effectively as to those small neutral airborne substances which are neither positively nor negatively charged. The length (distance from the air stream entering the electrostatic system to the point that it leaves the electrostatic system) of the electrostatic filter system is very long (usually over 2 inches long) in order to provide absolute filtration of airborne particles removal; otherwise, these small neutral non-charged airborne substances such as viruses and bacteria may flow through the filtering system in the air stream and may not be removed.

Secondly, moisture is usually removed and condensed on the (cathode) collector plates of the electrostatic system. As results, when a droplet of water is formed, the air gap between the tips of the water droplet overhanging on top of the anode plate surface becomes much smaller and the electrostatic force concentration at around the droplet area and degrade the efficiency of the rest of the electrostatic surfaces. This phenomenon also affects the design of the electrostatic filter system to have a much wider gap between the anode and the cathode plates resulting that the electrostatic (field) attraction force become much less effective on small airborne particles. As counter measure, higher power (potential energy) is required to be applied to the system in order to compensate the wider electrostatic gap. This makes the electrostatic system bulkier and not practical for subcompact air cleaners.

Thus there is a need for a more effective electrostatic filtration system that works on removing small airborne substances but requiring much smaller physical size body and less power consumption. This filtration system shall be able to remove most of the contaminant in the air including airborne particles, bacteria and viruses. The whole system shall be light and small enough for users to place it at desktop without occupying too much space while providing absolute clean air to users.

The present invention provides such a supercharged subcompact electrostatic field air filtration system.

### DISCLOSURE OF INVENTION

A supercharged electrostatic field air filtration system is an electronic air filtration system that can provide absolute clean air with a much smaller physical body than conventional electrostatic air filtration system with higher efficiency and less power consumption. This supercharged electrostatic field air filtration system is a generic system that has multiple applications. This supercharged electrostatic field air filtration system is also a generic air filtration system that can be applied to be used in cigarette fume removal device to prevent second hand smoking, burning-incense fume removal device and kitchen hood for removal of cooking fume. It can also be adapted to use as a filtration system to remove airborne matters in human's breath when installed in a face mask, hood and helmet.

The unique features of this invention are:
1. A dual function ionization system providing the first function as an ionic air cleaner that will remove most of the airborne matters from the ambient air. The second function is a pre-charging stage where the ambient air is bombarded with ionized air current such that all airborne particles become negatively charged before entering the subcompact electrostatic field filtration stage of the system. This will increase the effectiveness of the electrostatic field attraction force to drive the negatively charged particles to the cathode collector plates. This ionized air bombardment will also help to remove some of the moisture from the air stream before entering the subcompact electrostatic field filtration stage.
2. The gap between the anode and the cathode plates of the subcompact electrostatic field filtration stage are closer than conventional electrostatic filtration system.
3. The cathode and anode plates of the subcompact electrostatic field filtration stage setup are inclined at an angle to its feet or frame when the whole air filtration system is rested naturally on a surface of mounted on a wall. This helps the moisture condensation to slide off the surface of the collector plate before forming too large of a water droplet.
4. The surfaces of the anode and cathode plates are designed to be hybrid hydrophilic-hydrophobic, which incorporates both hydrophobic and hydrophilic characteristic into one surface. These features will optimize the shape of the condensed water droplet on both anode and cathode surfaces at overhanging and resting orientations.
5. The length of the electrostatic portion is much shorter than conventional design while still provide adequate distance to cover airborne particles' projectile travel distance through the electrostatic field filtration and be captured.
6. A synchronized high potential electricity circuit provides power to both ionization and electrostatic functions. This technique provides much higher efficiency and cost effectiveness on the application of the supercharged electrostatic field system.
7. A UV germicidal light system is added optionally to the supercharged electrostatic field system to neutralized the viruses and bacteria that carried by the air stream through the system.
8. An electrical fan is used as the driving power for the air stream to pass through the supercharged electrostatic field air cleaning system when used as a stand alone air filtration unit.
9. Provide positive pressure of absolute clean air to user when incorporated into a helmet, hood and face mask.

Since the size of this supercharged electrostatic field air filtration system is largely reduced while providing very high quality clean air, this invention is also a generic system that can be used in filtration of intake air system, filtration of exhausted air system. It can also used to remove airborne substances from human breaths when adapted to be used in mask, hood and helmet.

The results of this invention are to provide a high efficient filtration device to the user such that the air processed is clean and is bacteria and virus free. When adapted to a mask, hood or helmet, the user can breathe through this filtration device without requiring extra effort as compare to breathing heavily through convention paper filter mask. It can rely either on the human breath or electrical fan as the air flow source to move the air stream through the supercharged electrostatic field filtration system during the inhalation and exhalation processes.

It is an object of this present invention to provide a very compact supercharged electrostatic field filtration system to provide an absolute clean air environment.

Other features and advantages of the invention will appear from the following description in which the preferred embodiments have been set forth in detail, in conjunction with the accompanying drawings.

### BRIEF DESCRIPTION OF THE DRAWINGS

FIG. 1 depicts portion of the overall external view of the supercharged electrostatic air field filtration system. It is also generic to the supercharged electrostatic field UV germicidal air filtration system. It depicts portion of the housing with air flow entering from the inlet opening and clean air stream leaving through the outlet openings. It also depicts the location of the cross-sectional slicing plane A.

FIG. 2 depicts portion of the cross section view of supercharged electrostatic field air filtration system through plane A-A of FIG. 1. It depicts a portion of the sectioned housing with portions of the inlet and outlet air louver, a portion of the sectioned dual functions ionization bombardment system with portion of directional control target plate, a portion of subcompact electrostatic field filtration stage with portion of the electrostatic attraction to charged airborne matters, a portion of the electronic control box, a portion of the connecting cables, a portion of the moisture collection container, a portion of the electrical fan, a portion of the ionized air pocket with portion of the ionized air molecular flow, a portion of the air stream flowing through the system and a portion of the clean air pocket according to present invention.

FIG. 3 depicts portion of the supercharged electrostatic field air filtration system with UV light germicidal function through plane A-A of FIG. 1. It depicts a portion of the sectioned housing with portions of the inlet and outlet air louver, a portion of the sectioned dual functions ionization bombardment system with portion of directional control target plate, a portion of the subcompact electrostatic field filtration stage with portion of the electrostatic attraction to charged airborne matters, a portion of the UV light germicidal system, a portion of the electronic control box, a portion of the connecting cables, a portion of the moisture collection container, a portion of the electrical fan, a portion of the ionized air pocket, a portion of the air stream flowing through the system and a portion of the clean air pocket according to present invention.

FIG. 4 illustrates the ideal combo-hydro surface best suited for the supercharged electrostatic field filtration system. Bare metal surfaces are hydrophilic. FIG. 4A and FIG. 4B illustrates the advantage of using combo-hydro surface over hydrophilic surface with respect to size of overhanging water droplet. FIG. 4A illustrates under normal condition in horizontal position; it depicts the cross-section of a condensed water droplet hanging at the bottom of a hydrophilic surface of the metallic electrostatic element which includes both anode and cathode surfaces. It also depicts the width hanging height of the cross-section of the water droplet. FIG. 4B illustrates the basic structure of a combo-hydro surface and under affected condition in horizontal position; it depicts the cross-section of a condensed water droplet hanging at the bottom surface of the combo-hydro surface of the metallic electrostatic element which includes both anode and cathode surfaces. It also depicts the width hanging height of the cross-section of the water droplet. FIG. 4C illustrates the advantage of using inclined hydrophilic surface over horizontal hydrophilic surface with respect to size and height of resting droplet. It depicts a portion of the horizontal free-state boundary of the resting droplet as compare to a portion of the inclined free-state boundary of the resting droplet when rested on an inclined surface. FIG. 4D illustrates the advantage of using combo-hydro surface over hydrophilic surface with respect to size of overhanging water droplet when both surfaces are vertically oriented. It depicts a portion of the vertical free-state boundary of the resting droplet on a vertical hydrophilic surface as compare to a portion of the affected free-state boundary of the resting droplet when rested on a vertical combo-hydro surface with portion of hydrophilic surface and portions of hydrophobic surfaces. FIG. 4E illustrates the advantage of using combo-hydro surface over hydrophilic surface with respect to size of overhanging water droplet when both surfaces are inclined. It depicts a portion of the inclined free-state boundary of the resting droplet on an inclined hydrophilic surface as compare to a portion of the affected free-state boundary of the resting droplet when rested on an inclined combo-hydro surface with portion of hydrophilic surface and portions of hydrophobic surfaces according to present invention.

FIG. 5 illustrates the differences between the normal hydrophilic surface, polished hydrophilic surface and polished combo-hydro surface. FIG. 5A depicts portion of the cross-section of a hydrophilic surface. FIG. 5B depicts portion of cross-section of a polished hydrophilic surface. FIG. 5C depicts portion of the cross-section of a combo-hydro surface with portion of hydrophilic surface and portions of hydrophobic surfaces according to present invention.

FIG. 6 illustrates the wall mounting mechanism of the supercharged electrostatic field air filtration system. FIG. 6A depicts a portion of the back housing of the supercharged electrostatic field air filtration system, a portion of the opening for mechanical instrument to attach to. FIG. 6B depicts a portion of the back housing of the supercharged electrostatic field air filtration system, a portion of the opening, a portion of the wall and a portion of the fastener according to present invention.

FIG. 7 illustrates the office partition mounting mechanism of the supercharged electrostatic field air filtration system. FIG. 7A depicts a portion of the supercharged electrostatic field air filtration system, a portion of the hanger and a portion of the office partition. It also depicts the inlet air flow and the processed outgoing clean air flow. FIG. 7B depicts a portion of the cross section of the back housing of the supercharged electrostatic field air filtration system, a portion of the opening, and a portion of the hanging mechanism of the hanger according to present invention. FIG. 7C illustrates the integration of supercharged electrostatic field air filtration system into a partition. It depicts a portion of a partition with a portion of a recess pocket. It depicts a supercharged electrostatic air filtration system installed inside of the recess pocket. FIG. 7D illustrates the integration of supercharged electrostatic field filtration system into a wall. It depicts a portion of a wall with a portion of a recess pocket. It depicts a supercharged electrostatic field air filtration system installed inside of the recess pocket.

FIG. 8 illustrates the block diagram of the synchronized electrical control circuit of the supercharged electrostatic field air filtration with germicidal UV light system. It depicts the main control is connected to the power source. It also depicts the high voltage generator circuit, the multiplier circuit for the ionization system, the multiplier circuit for the electrostatic field system, the current protector for the collector plate of the electrostatic field system, the switch and current protector for the ionization directional target system, the fan, the UV control system, the UV germicidal system and the UV sensor according to present invention.

FIG. 9 illustrates the block diagram of the synchronized electrical control circuit of the supercharged electrostatic field air filtration system. It depicts the main control is connected to the power source. It also depicts the high voltage generator circuit, the multiplier circuit for the ionization system, the multiplier circuit for the electrostatic system, the current protector for the collector plate of the electrostatic field system, the switch and current protector for the ionization directional target system, and the fan according to present invention.

FIG. 10 illustrates the multiplier circuits. FIG. 10A depicts the basic multiplier cell which includes capacitors and diodes. FIG. 10B depicts the basic multiplier cells are connected in series and become the voltage multiplier circuit for the electrostatic field air filtration system. It also depicts portion of the anode collector plates and portion of the cathode collector plate which is connected to positive power source. FIG. 10C depicts the basic multiplier cells are connected in series and become the voltage multiplier circuit for the ionization system. It also depicts portion of the ionization needle and portion of the cathode director target which is connected to positive power source.

FIG. 11 depicts the concept to adapt this invention to face mask, hood and helmet. FIG. 11A depicts portion of the user's head, portion of the face mask, portion of the exhaust valve, a portion of supercharged electrostatic field air filtration system with a portion of an air hose connecting from the outlet opening of the supercharged electrostatic air filtration system to the face mask. This concept is also generic to the supercharged electrostatic field air filtration with germicidal UV light system. FIG. 11B depicts portion of the user's head, portion of the hood, portion of the exhaust valve, portions of supercharged electrostatic field air filtration system with a portion of an air hose connecting from the outlet opening of the supercharged electrostatic field air filtration system to the face mask. This concept is also generic to the supercharged electrostatic field air filtration with germicidal UV light system. FIG. 11C depicts portion of the user's head, portion of the helmet with portion of the built-in air cleaning system, portion of the inlet opening with portion of the airflow and portion of the exhaust valve. This built-in air filtration system is a supercharged electrostatic field air filtration system with the outlet opening directly release air into the inside of the helmet. This concept is also generic to adapt a supercharged electrostatic field air filtration with germicidal UV light system as the built-in air filtration system. FIG. 11D depicts portion of the user's head, portion of the face mask, portion of the exhaust valve, portion of supercharged electrostatic field air filtration system with a portion of an air hose connecting from the outlet opening of the supercharged electrostatic air filtration system to the face mask. This concept is also generic to the supercharged electrostatic field air filtration with germicidal UV light system.

FIG. 12 illustrates a synchronized supercharged electrostatic field air filtration system 1 being integrated into a wall opening as stated in FIG. 7 with mechanism to allow user access to remove the particle collector plate form the system for periodic cleaning. It is generic to partition wall and ceiling. It is also generic to apply to synchronized supercharged electrostatic field air filtration with UV light germicidal system 22. FIG. 12A illustrates a synchronized supercharged electrostatic field air filtration system 1 being integrated into a wall opening during operation. It depicts portion of a partition wall 58, a portion of recess pocket 99, a portion of synchronized supercharged electrostatic field air filtration system 1, a portion of cathode plate 15, a portion of cathode plate handle 117, a portion of latching mechanism 122, a portion of locking device 119, a portion of lock latch 120, a portion of hinge 118, a portion of hinge base 121, a portion of inlet airflow 18 and a portion of clean air stream 31. FIG. 12B illustrates a synchronized supercharged electrostatic field air filtration system 1 being integrated into a wall opening during maintenance service to access to the collector plate. It depicts portion of a partition wall 58, a portion of recess pocket 99, a portion of synchronized supercharged electrostatic field air filtration system 1, a portion of cathode plate 15, a portion of cathode plate handle 117, a portion of latching mechanism 122, a portion of locking device 119, a portion of lock latch 120, a portion of hinge 118 and a portion of hinge base 121.

### MODES FOR CARRYING OUT THE INVENTION

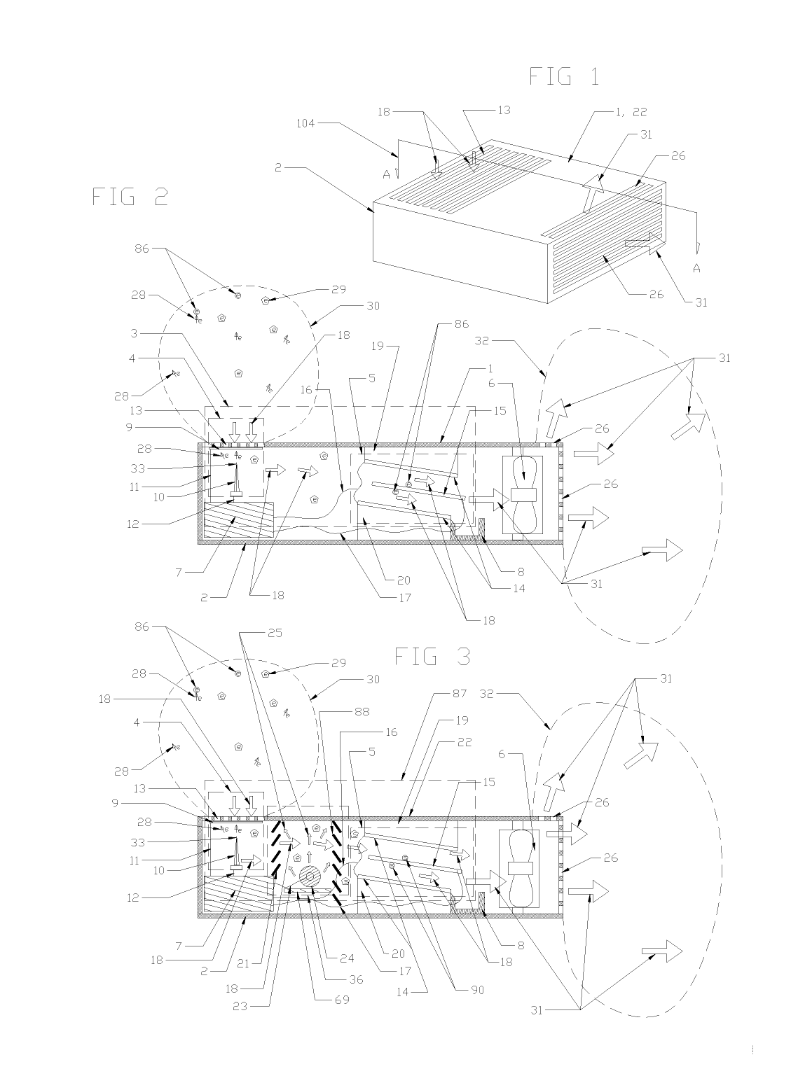

FIG. 1 is the generic isometric view of a synchronized supercharged electrostatic field air filtration system 1 and synchronized supercharged electrostatic field air filtration with UV light germicidal system 22. It is enclosed in a housing 2 with at least one inlet opening 13 for airflow 18 entering inside of housing 2 where air filtration processes take place. Housing 2 has at least one outlet opening 26 for clean air stream 31 to leave the air cleaning system. Cross section plane 104 is located relatively to the center of the housing 2. Further detail of the synchronized supercharged electrostatic field air filtration system 1 is described in FIG. 2 showing the cross-section of the system through cross section plane 104. Further detail of the synchronized supercharged electrostatic field air filtration with UV light germicidal system 22 is described in FIG. 3 showing the cross-section of the system through cross section plane 104.

FIG. 2 is the cross-sectional view of a synchronized supercharged electrostatic field air filtration system 1 which is consisted of the housing 2, the supercharged electrostatic field system 3, the PCBA (printed circuit board assembly) 7, condensation container 8 and the fan 6.

Housing 2 provides the external boundaries for the synchronized supercharged electrostatic field air filtration system 1 isolating it from the outside ambient air. It is equipped with the inlet opening 13 for air inlet to the synchronized supercharged electrostatic field air filtration system 1 and the outlet opening 26 for air outlet from the synchronized supercharged electrostatic field air filtration system 1. Housing 2 also provides the mechanical support for all the components and systems within housing 2.

The supercharged electrostatic field system 3 consists of dual functions ionization system 4 and the subcompact electrostatic field system 5. Dual functions ionization system 4 consists of ionization pin module 10 and cathode target 9. Ionization pin module 10 is connected to PCBA 7 by connection wire 12 and cathode target 9 is connected to PCBA 7 by connection wire 11. Within the dual functions ionization system 4, needlepoint 33 produces high amount of negative ions when high negative DC voltage is applied to it by the PCBA 7 which is connected to external power source. This is by far the most effective process of ions generation. This negative ion generators cause an electron to be added to the molecules of Oxygen, Nitrogen and other trace gases in the surrounding air and form ionized air molecule 28. This process creates ionized air molecule 28 with a negative charge. When the ionized air molecule 28 become negatively charged, it get excited and will collide with debris matters 86 such as pollen, mold spores, dust, bacteria, tobacco smoke, moisture and many other particles which are airborne. The negative charge of ionized air molecule 28 is then transferred to the debris matter 86, which is then transforms to negatively charged airborne matter 29. Surrounding this newly negatively charged airborne matter 29 are many other particles that are positively charged. These positively charged particles are drawn to this negatively charged airborne matter 29 and begin to build-up, eventually these particles become too heavy and fall harmlessly to ground by gravitational force. These ionized air molecules 28 become concentrated around the inlet opening 13 and forms an ionized air pocket 30 surrounding the inlet opening 13. As the fan 6 is operating, a pressure drop in the system will form airflow 18 to move from the ionized air pocket 30 into the housing 2 through the inlet opening 13. It results that all airborne matters carried by airflow 18 will be passing through the ionized air pocket 30 zone before they can enter into the inside of housing 2. These airborne matters will be either too heavy and drop off from air, or become negatively charged airborne matters 29. Cathode target 9 increase the potential energy at the ionization pin tip 33 resulting in higher ionization rate and causes the ionized air molecules 28 to flow in the directional path from the ionization pin tip towards the cathode target 9. Cathode target 9 can also be perforated to increase the air flow volume.

PCBA 7 is also connected to anode plate 14 by connection cable 16 and connected to cathode plate 15 by connection cable 17 providing the electrical control and power to the subcompact electrostatic field system 5. Subcompact electrostatic field system 5 is supported by housing 2 by mounting support 19 and mounting support 20. Mounting support 19 and mounting support 20 block off all air passage to the fan inlet except the air passage in between the cathode plate 15 and anode plate 14 such that all air will be subjected to the electrostatic field particle removal process. Condensation container 8 is supported by the housing 2 and placed under the subcompact electrostatic field system 5 to capture the drained off condensation generated by the subcompact electrostatic field system 5.

When the subcompact electrostatic field system 5 is operating, a negative voltage of 2000+V is sent to the anode plate 14 with the cathode plate 15 connected to the electrically positive. It results that the surface of the anode plate 14 becomes highly negatively charged and causes an electrostatic field to form between the anode plate 14 and the cathode plate 15, which becomes equally highly positively charged. This electrostatic field causes an uniform distribution of electrons on the surface of anode plate 14, and an equal and uniformly distributed deficiency of electrons on the cathode plate 15. The voltage graduation is uniform throughout this field, except at its edges and near sharp corners of the plates/fins.

As the airflow 18 passes from the dual functions ionization system 4 into the subcompact electrostatic field system 5, airflow 18 carries the negatively charged airborne matters 29 into the electrostatic field of the subcompact electrostatic field system 5. The electrostatic field has stronger effect on these negatively charged airborne matters 29 than if they are neutral airborne matters. These negatively charged airborne matters 29 also have stronger tendency to be attracted to the cathode plate 15 and eventually become debris matters 86 adhered to cathode plate 15 after the negative ions are transferred to cathode plate 15. This cathode plate 15 is detachable and requires periodic cleaning to remove excessive attached debris matters 86.

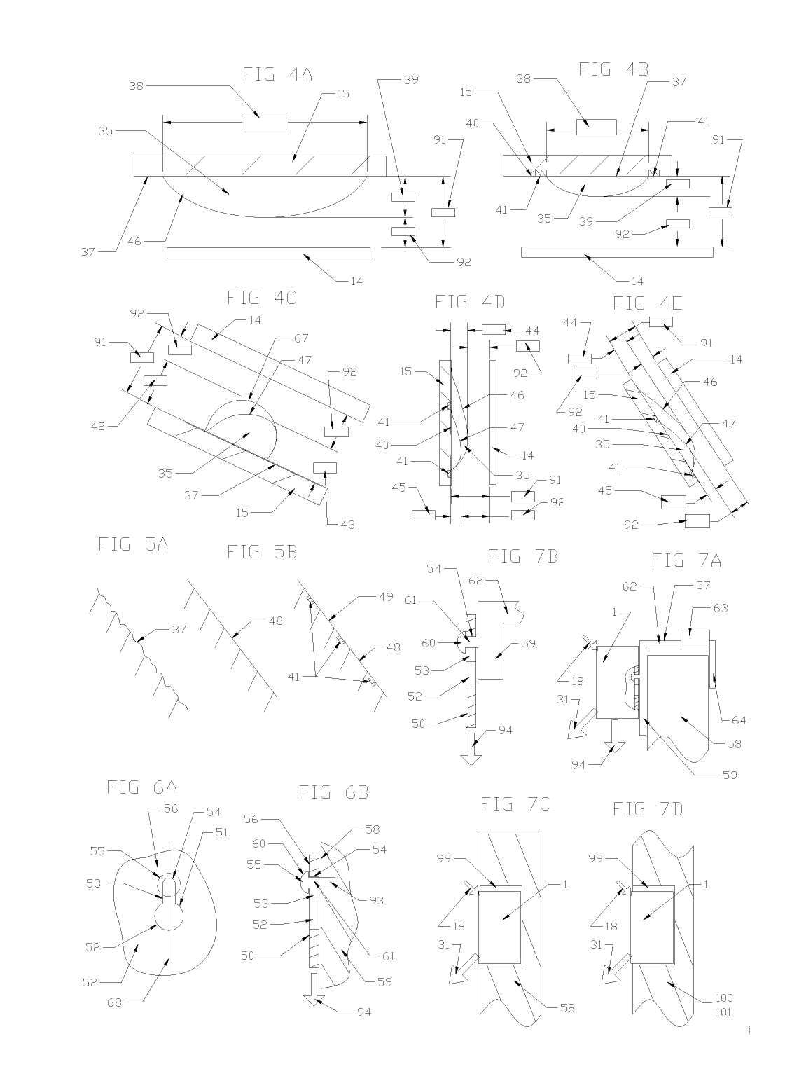

The subcompact electrostatic field system 5 is optimized by setting it tilted at an angle from horizontal. This feature helps to drain off any condensation on the surfaces of the electrostatic plates. Further details are explained in FIG. 3 and FIG. 4. All moisture in airflow 18 are removed by the subcompact electrostatic field system 5 and condensation occurs on cathode plate 15 will be drained off by gravity to condensation container 8. The air flow leaving the subcompact electrostatic field system 5 becomes clean air stream 31 with no airborne matters and very dry at this stage. Electrostatic air filtration processes are proven to be capable to remove airborne matters down to 0.01 microns in size. Some water in condensation container 8 will eventually vaporize and be carried away by clean air stream 31 and result in increasing the moisture level of the clean air stream 31. Any matter that cannot be vaporized will remain in the condensation container 8 and will not contaminate clean air stream 31. The air pressure differential generated by the operating fan 6 drives the clean air stream 31 to the ambient through outlet opening 26 producing a clean air pocket 32 environment for users.

FIG. 3 is the synchronized supercharge electrostatic field air filtration with germicidal UV light system 22 which is consisted of the housing 2, the supercharged electrostatic field with germicidal UV light system 87, the PCBA (printed circuit board assembly) 7, condensation container 8 and the fan 6.

Housing 2 provides the external boundaries for the synchronized supercharge electrostatic field air filtration with germicidal UV light system 22 isolating it from the outside ambient air. It is equipped with the inlet opening 13 for air inlet to the synchronized supercharge electrostatic field air filtration with germicidal UV light system 22 and the outlet opening 26 for air outlet from the synchronized supercharge electrostatic field air filtration with germicidal UV light system 22. Housing 2 also provides the mechanical support for all the components and systems within housing 2.

The supercharged electrostatic field with germicidal UV light system 87 consists of dual functions ionization system 4, UV light germicidal chamber 36 and the subcompact electrostatic field system 5. Dual functions ionization system 4 consists of ionization pin module 10 and cathode target 9. Ionization pin module 10 is connected to PCBA 7 by means of connection wire 12 and cathode target 9 is connected to PCBA 7 by connection wire 11. Within the dual functions ionization system 4, needlepoint 33 produces high amount of negative ions when high negative DC voltage is applied to it by the PCBA 7 which is connected to external power source. This is by far the most effective way of ions generation. This negative ion generators cause an electron to be added to molecules of Oxygen, Nitrogen and other trace gases in the surrounding air and forms ionized air molecule 28. This process creates ionized air molecule 28 with a negative charge. When the ionized air molecule 28 become negatively charged, it get excited and will collide with debris matters 86 such as pollen, mold spores, dust, bacteria, tobacco smoke, moisture and many other particles which are airborne. The negative charge of ionized air molecule 28 is then transferred to the debris matter 86, which is then transforms to negatively charged airborne matter 29. Surrounding this newly negatively charged airborne matter 29 are many other particles that are positively charged. These positively charged particles are drawn to this negatively charged airborne matter 29 and begin to build-up, eventually these particles will build-up to a point and become too heavy and fall harmlessly to ground by gravitational force. These ionized air molecules 28 become concentrated around the inlet opening 13 and forms an ionized air pocket 30 surrounding the inlet opening 13. As the fan 6 is operating, a pressure drop in the system will cause the air to form airflow 18 and airflow 18 will move from the ionized air pocket 30 into the housing 2 through the inlet opening 13. It results that all airborne matters carried by airflow 18 will be passing through the ionized air pocket 30 zone before they can enter into the inside of the housing 2. These airborne matters will be either become too heavy and drop to ground by gravitational force, or become negatively charged airborne matters 29. Cathode target 9 increases the potential energy at the ionization pin tip 33 resulting in higher ionization rate and causing the ionized air molecules 28 to flow in the directional path from the ionization pin tip towards the cathode target 9. Cathode target 9 can also be perforated to increase air flow volume.

The UV light germicidal chamber 36 is consisted of a germicidal UV light source 96, which is connected to PCBA 7 by connection wire 23, reflective surface 69, a light blocking louver 21 to block of UV ray 25 generated by germicidal UV light source 96 from escaping to the ionic pre-charge system 4 chamber; and a light blocking louver 88 to block of UV ray 25 from escaping to the subcompact electrostatic field system 5.

Airflow 18 leaving dual functions ionization system 4 enters the UV light germicidal chamber 36 through the light blocking louver 21 and travels through the open area inside the UV light germicidal chamber 36. Germicidal UV ray 25 is generated when germicidal UV light source 96 is in operation. These germicidal UV rays 25 will work on the airflow 18 passing through and will neutralize or sterilize any living organism including bacteria and viruses airborne in airflow 18. Reflective surface 69 helps to reflect and focus the germicidal UV rays 25 towards airflow 18 and improve the neutralization action efficiency. Light blocking louver 21 is oblique with non-reflective surfaces such that all germicidal UV rays 25 will be absorbed when shining onto light blocking louver 21. Light blocking louver 21 also adds turbulence to the airflow 18. Turbulence flow helps to minimize any stagnation point/spot for air and also increases the exposure time for air stream with the airborne particles under the UV rays.

Airflow 18 leaves the UV light germicidal chamber 36 through light blocking louver 88 to subcompact electrostatic field system 5. Light blocking louver 88 is oblique with non-reflective surfaces such that all germicidal UV rays 25 will be absorbed when shining onto light blocking louver 88. At this stage, the negatively charged airborne matters 29 in airflow 18 become sterilized negatively charged airborne matters 89. Light blocking louver 88 also adds turbulence to the airflow 18. Turbulence flow helps to minimize any stagnation point/spot for air and also slows the speed the air stream when passing through the subcompact electrostatic field system 5; hence increases the efficiency of electrostatic field in capturing the airborne particles.

PCBA 7 is also connected to anode plate 14 by connection cable 16 and connected to cathode plate 15 by connection cable 17 providing the electrical control and power to the subcompact electrostatic field system 5. Subcompact electrostatic field system 5 is supported by housing 2 by mounting support 19 and mounting support 20. Mounting support 19 and mounting support 20 block off all air passage to the fan inlet except the air passage in between the cathode plate 15 and anode plate 14 such that all air flow through the system will be subjected to the electrostatic field particle removal process. Condensation container 8 is supported by the housing 2 and placed under the subcompact electrostatic field system 5 to capture the drained off condensation generated by the subcompact electrostatic field system 5.

When the subcompact electrostatic field system 5 is operating, a negative voltage of 2000+V is sent to the anode plate 14 with the cathode plate 15 connected to the electrically positive. It results that the surface of the anode plate 14 becomes highly negatively charged and causes an electrostatic field to form between the anode plate 14 and the cathode plate 15, which becomes equally highly positively charged. This electrostatic field causes an uniform distribution of electrons on the surface of anode plate 14, and an equal and uniformly distributed deficiency of electrons on the cathode plate 15. The voltage graduation is uniform throughout this field, except at its edges and near sharp corners of the plates/fins.

As the airflow 18 passes from the ionic pre-charge system 4 into the subcompact electrostatic system field 5, airflow 18 carries the negatively charged airborne matters 29 into the electrostatic field of the subcompact electrostatic field system 5. The electrostatic field exerts a repulsive force pushing on these negatively charged airborne matters 29 than if they are neutral airborne matters. Thus these negatively charged airborne matters 29 be pushed and attracted to the cathode plate 15 and eventually become debris matters 86 adhered to cathode plate 15 because the negative ions are attracted by cathode plate 15. This cathode plate 15 is detachable and requires periodic cleaning to remove excessive attached debris matters 86.

As the airflow 18 enters the subcompact electrostatic field system 5, airflow 18 carries the sterilized negatively charged airborne matters 89 into the electrostatic field of the subcompact electrostatic field system 5. The electrostatic field has stronger effect on these sterilized negatively charged airborne matters 89 than if they are neutral airborne matters. These sterilized negatively charged airborne matters 89 also have stronger tendency to be attracted to the cathode plate 15 and eventually become sterilized debris matters 90 adhered to cathode plate 15 after the negative ions are transferred to cathode plate 15. This cathode plate 15 is detachable and requires periodic cleaning to remove excessive attached sterilized debris matters 90.

The subcompact electrostatic field system 5 is optimized to be set tilted at an angle from horizontal. This feature helps to drain off any condensation on the surfaces of the electrostatic plates. Further details are explained in FIG. 3 and FIG. 4. All moisture in airflow 18 are removed by the subcompact electrostatic field system 5 and condensation occurs on cathode plate 15 will be drained off by gravity to condensation container 8. The air flow leaving the subcompact electrostatic field system 5 becomes clean air stream 31 with no airborne matters and very dry at this stage. Electrostatic air filtration processes are proven to be capable to remove airborne matters down to 0.01 microns size. The water in condensation container 8 will eventually vaporize and be carried away by clean air stream 31 and result in increasing the moisture level of the clean air stream 31. Any matter that cannot be vaporized will remain in the condensation container 8 and will not contaminate clean air stream 31. The air pressure differential generated by the operating fan 6 drives the clean air stream 31 to the ambient through outlet opening 26 producing a clean air pocket 32 environment for users.

FIG. 4A and FIG. 4B illustrate the advantage of using combo-hydro surface over hydrophilic surface with respect to size of overhanging water droplet. FIG. 4A is a normal electrostatic system with conductive hydrophilic surface 37 on all the surfaces of the anode and cathode plates. The overhanging free-state boundary 46 represents the amount of condensed water droplet 35 before the instance that the droplet's critical surface tension is equal to the critical surface tension of water. The water droplet 35 will drop from the overhanging hydrophilic surface 37 once the droplet's critical surface tension is larger than the critical surface tension of water. The diameter of water droplet 38 represents the maximum size of the water droplet 35 before the instance that the droplet's critical surface tension is equal to the critical surface tension of water. The hanging height 39 represents the maximum size of the water droplet 35 before the instance that the droplet's critical surface tension is equal to the critical surface tension of water. The hanging height 39 is proportional to the diameter of water droplet 38 which is translated into circumference for determination of the hanging strength of the water droplet 35 by the critical surface tension. De-ionized water has a critical surface tension of 73 dynes/cm. The combination of the circumference of water droplet 35 and the critical surface tension of water is equal or less than the weight of the water droplet 35. When the circumference of water droplet 35 is larger, the allowable weight of the water droplet 35 is also larger and the resulting hanging height 39 is also larger. The effective electrostatic gap 92 is the shortest distance between the cathode plate 15 and the anode plate 14 of the subcompact electrostatic field system 5; and is also equal to the nominal gap 91 minus the hanging height 39. The effective electrostatic gap 92 is smaller when the overhanging water droplet 35 is larger inside an operating subcompact electrostatic field system 5.

FIG. 4B is a subcompact electrostatic field system 5 with conductive combo-hydro surfaces 40 on all the surfaces of the anode and cathode. The combo-hydro surface 40 is comprised of the basic hydrophilic surface 37 inlaid with portion of hydrophobic surfaces 41. Hydrophobic surfaces 41 reject water and are usually non conductive; and will not be ideal for attracting negatively airborne charged particles 29. On the other hand, these inlaid hydrophobic surfaces 41 help to confine the size of the water droplet 35 by limiting the circumference of the water droplet 35. The resulting combo-hydro surface 40 consists of hydrophobic surfaces 41 inlaid into the hydrophilic surface 37 in patterns that the sizes of water droplets 35 formed will be optimized with respect to the allowable conductive surface area for attraction of negatively charged airborne particles 29 with optimized nominal gap 91 in construction of the subcompact electrostatic field system 5. The overhanging free-state boundary 46 represents the amount of condensed water droplet 35 before the instance that the droplet's critical surface tension is equal to the critical surface tension of water. The water droplet 35 will drop from the overhanging combo-hydro surface 40 once the droplet's critical surface tension is larger than the critical surface tension of water. The diameter of water droplet 38 represents the maximum size of the water droplet 35 before the instance that the droplet's critical surface tension is equal to the critical surface tension of water. The hanging height 39 represents the maximum size of the water droplet 35 before the instance that the droplet's critical surface tension is equal to the critical surface tension of water. The hanging height 39 is proportional to the diameter of water droplet 38 which is translated into circumference for determination of the hanging strength of the water droplet 35 by the critical surface tension. De-ionized water has a critical surface tension of 73 dynes/cm. The combination of the circumference of water droplet 35 and the critical surface tension of water is equal or less than the weight of the water droplet 35. When the circumference of water droplet 35 is larger, the allowable weight of the water droplet 35 is also larger and the resulting hanging height 39 is also larger. The effective electrostatic gap 92 is the shortest distance between the cathode plate 15 and the anode plate 14 of the subcompact electrostatic field system 5; and is also equal to the nominal gap 91 minus the hanging height 39. The effective electrostatic gap 92 is smaller when the overhanging water droplet 35 is larger inside an operating subcompact electrostatic system 5.

FIG. 4C illustrates the advantage of using inclined hydrophilic surface 37 over horizontal hydrophilic surface 37 with respect to size and height of resting water droplet 35. Water droplet 35 is rested on top of cathode plate 15. Horizontal free-state boundary 67 represents the maximum external boundary of the water droplet 35 before the instance that the droplet's critical surface tension is equal to the critical surface tension of water when the subcompact electrostatic field system 5 is oriented horizontally. The water droplet 35 will roll down from the hydrophilic surface 37 once the droplet's critical surface tension is larger than the critical surface tension of water. The free height 42 represents the maximum height of the water droplet 35. Affected state boundary 47 represents the maximum external boundary of the water droplet 35 before the instance that the droplet's critical surface tension is equal to the critical surface tension of water when the subcompact electrostatic field system 5 is oriented at an angle to the horizontal reference. The affected height 43 represents the maximum height of the water droplet 35 when the subcompact electrostatic system 5 is oriented at an angle to the horizontal reference. The nominal electrostatic gap 91 is equal to the sum of the effective electrostatic gap 92 and the free height 42 for the horizontal subcompact electrostatic field system 5. The nominal electrostatic gap 91 is also equal to the sum of the effective electrostatic gap 92 and the affected height 43 for the inclined subcompact electrostatic field system 5. The affected height 43 is smaller than free height 42; it results that the nominal electrostatic gap 91 of an inclined subcompact electrostatic field system 5 will be smaller than the nominal electrostatic gap 91 of a horizontal subcompact electrostatic field system 5. Hence, the physical size of the subcompact electrostatic field system 5 is smaller when oriented in an inclined position than when it is oriented in horizontal position.

FIG. 4D illustrates the advantage of using combo hydro surface 41 over a hydrophilic surface 37 in a vertical subcompact electrostatic field system 5 with respect to size and height of resting water droplet 35. Water droplet 35 is adhered to a vertical surface of cathode plate 15. Free-state boundary 46 represents the maximum external boundary of the water droplet 35 on a hydrophilic surface 37 before the instance that the droplet's critical surface tension is equal to the critical surface tension of water when the subcompact electrostatic field system 5 is oriented vertically. The free height 44 represents the maximum height of the water droplet 35 on a hydrophilic surface 37. Affected state boundary 47 represents the maximum external boundary of the water droplet 35 on a combo hydro surface 41 before the instance that the droplet's critical surface tension is equal to the critical surface tension of water when the subcompact electrostatic field system 5 is oriented vertically. The affected height 43 represents the maximum height of the water droplet 35 attached to a combo hydro surface 41 when the subcompact electrostatic field system 5 is oriented vertically. The nominal electrostatic gap 91 is equal to the sum of the effective electrostatic gap 92 and the free height 42 for the vertical subcompact electrostatic field system 5 with hydrophilic surfaces 37. The nominal electrostatic gap 91 is also equal to the sum of the effective electrostatic gap 92 and the affected height 43 for the vertical subcompact electrostatic field system 5; as the affected height 43 is smaller than free height 42, it results that the nominal electrostatic gap 91 of a vertical subcompact electrostatic field system 5 with combo hydro surface 41 will be smaller than the nominal electrostatic gap 91 of a vertical subcompact electrostatic field system 5 with hydrophilic surfaces 37. Hence, the physical size of the subcompact electrostatic field system 5 is smaller when equipped with combo hydro surfaces 41 than when it is with hydrophilic surfaces 37.

FIG. 4E illustrates the advantage of using combo hydro surface 41 over a hydrophilic surface 37 in an inclined subcompact electrostatic system 5 with respect to size and height of resting water droplet 35. Water droplet 35 is adhered to an inclined surface of cathode plate 15. Free-state boundary 46 represents the maximum external boundary of the water droplet 35 on a hydrophilic surface 37 before the instance that the droplet's critical surface tension is equal to the critical surface tension of water when the subcompact electrostatic field system 5 is inclined. The free height 44 represents the maximum height of the water droplet 35 on a hydrophilic surface 37. Affected state boundary 47 represents the maximum external boundary of the water droplet 35 on a combo hydro surface 41 before the instance that the droplet's critical surface tension is equal to the critical surface tension of water when the subcompact electrostatic field system 5 is inclined. The affected height 43 represents the maximum height of the water droplet 35 attached to a combo hydro surface 41 when the subcompact electrostatic field system 5 is inclined. The nominal electrostatic gap 91 is equal to the sum of the effective electrostatic gap 92 and the free height 42 for the inclined subcompact electrostatic field system 5 with hydrophilic surfaces 37. The nominal electrostatic gap 91 is also equal to the sum of the effective electrostatic gap 92 and the affected height 43 for the inclined subcompact electrostatic system 5. The affected height 43 is smaller than free height 42; it results that the nominal electrostatic gap 91 of an inclined subcompact electrostatic field system 5 with combo hydro surface 41 will be smaller than the nominal electrostatic gap 91 of an inclined subcompact electrostatic field system 5 with hydrophilic surfaces 37. Hence, the physical size of the subcompact electrostatic field system 5 is smaller when equipped with combo hydro surfaces 41 than when it is with hydrophilic surfaces 37.

FIG. 5 illustrates the differences between the normal hydrophilic surface, polished hydrophilic surface and polished combo-hydro surface. FIG. 5A depicts the cross-section of a hydrophilic surface 37 formed by general machining process. When water condenses on this surface, it will accumulate until the weight of the water body equals to the combination of the critical surface tension of water and the total length of the cross section edge which is the longest of the 3 illustrated surfaces in FIG. 4.

FIG. 5B depicts the cross-section of a polished hydrophilic surface 48. When water condenses on this surface, it will accumulate until the weight of the water body equals to the combination of the critical surface tension of water and the total length of the cross section edge. The maximum size of the condensed water droplet in FIG. 5B configuration is smaller than the one from FIG. 5A configuration.

FIG. 5C depicts the cross-section of a polished combo hydro surface 49 which is comprised of polished hydrophilic surface 48 with implanted hydrophobic surfaces 41. When water condenses on this surface, it will accumulate until the weight of the water body equals to the combination of the critical surface tension of water and the total length of the cross section edge. The implanted hydrophobic surfaces 41 set the limits of the length of the cross section edge and minimize the size of the water condensation. The maximum size of the condensed water droplet in FIG. 5C configuration is smaller than both from FIG. 5A and FIG. 5B configurations.

FIG. 6 illustrates the vertical surface mounting mechanism of the supercharged electrostatic air field filtration system. One set or more of hanging mounting holes 51 and hanger hardware 55 can be used to facilitate the hanging function of a supercharged electrostatic field air filtration system to a vertical mounting surface 56. FIG. 6A depicts a portion of the back housing 50 of the supercharged electrostatic field air filtration system with a hanging mounting hole 51 for easy mount and dismount application. The hanging mounting hole 51 is comprised of a clearance opening 52, neck opening 53 and hole end 54. The clearance opening 52 is located at the lower portion of the hanging mounting hole 51. FIG. 6B is the cross sectional illustration of FIG. 6A along the centerline 68. In FIG. 6B, the hanger hardware 55 is anchored to the partition wall 58 with hardware anchor 93 and holds the vertical mounting surface 56 in place. This hanger hardware 55 can be a screw, stud and any other mechanical components that can facilitate the function of providing hanging support to the back housing 50 through the hanging mounting hole 51. In operation the hanger hardware 55 inserts into the hanging mounting hole 51 through the clearance opening 52. The hanger head 60 passes and clear the back housing 50 and let the hanger stud 61 to be engaged with the back housing 50. The back housing 50 is then moved downward and the hanger stud 61 will slide between the side walls of the neck opening 53 until it is stopped by the hole end 54. The hanger head 60 is wider than the neck opening 53. The gravitational force 94 exerts on the back housing 50 causes the hanging mounting hole 51 of the back housing 50 to latch with the hanger hardware 55 and stay hanging on to the vertical mounting surface 56 with the hole end 54 resting on the hanger stud 61. This illustrated mounting mechanism is generic to both synchronized supercharged electrostatic field air filtration system 1 and synchronized supercharge electrostatic field air filtration with germicidal UV light system 22.

FIG. 7 illustrates the office partition mounting mechanism of the supercharged electrostatic field filtration system with back housing 50 equipped with hanging mounting hole 51 as illustrated in FIG. 5A. FIG. 7A illustrates the overall application of partition wall mounting mechanism which is generic to both synchronized supercharged electrostatic field air filtration system 1 and synchronized supercharge electrostatic field air filtration with germicidal UV light system 22. The synchronized supercharged electrostatic field air filtration system 1 is attached to the partition hanger 57. The attachment mechanism is further illustrated in FIG. 7B. Partition hanger 57 carrying the synchronized supercharged electrostatic field air filtration system 1 is mounted onto the top edge of the partition wall 58 and is kept in place by gravitational force 94. The airflow 18 from the ambient travels into the synchronized supercharged electrostatic field air filtration system 1/the synchronized supercharged electrostatic field air filtration with germicidal UV light system 22 and leaves as clean air stream 31 after the filtration processes.

Partition hanger 57 serves 2 functions. Firstly, it serves as the hanging mechanism to provide mechanical means to facilitate mounting functions to the top edge of the partition wall. Partition hanger 57 consists of hanger bar 62, which is connected to the hanger arm 59 at one end and hanger spring 63 at the other end. The other end of hanger spring 63 is connected to the support 64. Hanger bar 62, hanger arm 59 and support 64 provide the mechanical limits for the partition wall 58 such that with gravitational force 94 pulling the partition hanger 57 towards ground, partition hanger 57 will always be resting on top of the top edge of the partition wall 58. Hanger spring 63 provides the adjustment function to the partition hanger 57 such that the clearance between the surface of the partition wall 58 and the contacting surfaces of the hanger arm 59 and support 64 is to be optimized Partition hanger 57 will function even without the hanger spring 63 function with the support 64 directly connected to the hanger bar 62. However, the clearance between the hanger arm 59 and the support 64 has to be larger in order to accommodate different thickness of available office partitions. Hanger spring 63 can be self adjusting preloaded spring mechanism or manual adjustment to accommodate the mating partition wall thickness.

FIG. 7B is the cross sectional illustration of the second function of the partition hanger 57, providing support to the synchronized supercharged electrostatic field air filtration system 1. The hanger arm 59 provides support to the hanger stud 61. The end of the hanger stud 61 is the hanger head 60 with larger body than hanger stud 61.

In operation the hanger head 60 is inserted into the hanging mounting hole 51 through the clearance opening 52. The hanger head 60 passes and clear the back housing 50 and let the hanger stud 61 to be engaged with the back housing 50. The back housing 50 is then moved downward and the hanger stud 61 will slide between the side walls of the neck opening 53 until it is stopped by the hole-end 54. The hanger head 60 is wider than the neck opening 53. The gravitational force 94 exerts on the back housing 50 causes the hanging mounting hole 51 of the back housing 50 to latch with the hanger head 60 and stay hanging on to the partition hanger 57 with the hole end 54 resting on the hanger stud 61. It results that the synchronized supercharged electrostatic field air filtration system 1 is securely mounted onto the top of the partition wall 58.

The synchronized supercharged electrostatic field air filtration system 1 is mounted to the upper portion of the partition wall 58 with the help of the partition hanger 57. This optimized the air cleaning operation of the synchronized supercharged electrostatic field air filtration system 1 by allowing airflow 18 from the ambient enters and clean air stream 31 leaves in the most efficient manner providing clean air to the user working in office cubicle where office partitions are common. This method of mounting an air cleaner onto a partition is generic to ionic air cleaner, ionic air cleaner with germicidal function, electrostatic field air cleaner and electrostatic field air cleaner with germicidal function.

FIG. 7C depicts a synchronized supercharged electrostatic field air filtration system 1 or a synchronized supercharged electrostatic field air filtration with germicidal UV light system 22 being integrated into a partition 58. Partition 58 is equipped with a recess pocket 99 for accommodating a synchronized supercharged electrostatic field air filtration system 1 or a synchronized supercharged electrostatic field air filtration with germicidal UV light system 22 being integrated into a partition 58. The airflow 18 from the ambient travels into the synchronized supercharged electrostatic field air filtration system 1/the synchronized supercharged electrostatic field air filtration with germicidal UV system 22 and leaves as clean air stream 31 after the filtration processes. This method of integrating an air cleaner into a partition is generic to ionic air cleaner, ionic air cleaner with germicidal function, electrostatic field air cleaner and electrostatic field air cleaner with germicidal function.

FIG. 7D depicts a synchronized supercharged electrostatic field air filtration system 1 or a synchronized supercharged electrostatic field air filtration with germicidal UV light system 22 being integrated into a wall 100 or ceiling 101. Wall 100 or ceiling 101 is equipped with a recess pocket 99 for accommodating a synchronized supercharged electrostatic field air filtration system 1 or a synchronized supercharged electrostatic field air filtration with germicidal UV light system 22 being integrated into a wall 100 or ceiling 101. This concept of integrating into wall 100 and ceiling 101 are generic to buildings as well as automobiles, track vehicles, trains, ships and airplanes. The airflow 18 from the ambient travels into the synchronized supercharged electrostatic field air filtration system 1/the synchronized supercharged electrostatic field air filtration with germicidal UV light system 22 and leaves as clean air stream 31 after the filtration processes. This method of integration is also generic to ionization air filtration device, ionization air filtration device with UV light germicidal function, electrostatic field air filtration device, electrostatic field air filtration device with germicidal function, ionization air filtration device with electrostatic field air filtration function, and ionization air filtration device with both electrostatic field air filtration and UV light germicidal functions.

FIG. 8 is a functional diagram of a preferred embodiment of the electrical control circuit of the synchronized supercharged electrostatic field air filtration with germicidal UV light system 22. Electrical connections 74 provide the conductivities among all the functions within the system. The main control 71 receives power input from power source 70. The main control 71 has electrical circuit function that receives electrical signals from various signal input devices and sends out driver functions to subsystems to perform correlated operations. The main control 71 has regulator to restrict the input voltage to provide a steady and constant voltage to the input of the high voltage converter 72 and to germicidal UV light system 24. High voltage converter 72 comprises of oscillator circuit 102 and step-up transformer circuit 103. The oscillator circuit 102 converts a DC power source into a pulsating/oscillating DC power source as the input power source to at least one step-up transformer circuit 103 which in turn produces a high oscillating negative voltage output 95. This high oscillating negative voltage output 95 is sent to the input of 2 voltage multipliers 73. The first voltage multiplier 73 produces a high constant negative voltage which is then sent to the conductive ionization needle 75 where ionization occurs. Target 76 is made of conductive material and is connected to the positive voltage supply of the main control 71 through a current flow protector 77 and a switch 78. Positively charged target 76 increases the electrical potential at the ionization needle 75 and increases the rate of ionization. Positively charged target 76 also influence the direction of the ionized air flow to move along a path with direction pointing from the ionization needle 75 towards the target 76. The current flow protector 77 protects the back flow of electricity collected by the target 76 from the ionized air flow to the main control 71. The switch 78 provides the option of applying electrical connection to the target 76. Positively charged target 76 helps to lower the ionization voltage requirement at the ionization needle 75.

The second voltage multiplier 73 produces a high constant negative voltage which is then sent to the negative plates 79, which is of conducting material, of the subcompact electrostatic field system 5. Positive collector 80, which is made of conductive material, of subcompact electrostatic field system 5 is connected to the positive voltage supply of the main control 71 through a current flow protector 77.

The input voltage regulating function of main control 71 is very important to this preferred embodiment. For example, a 12 VDC regulated power supply has a tolerance of +/−0.3V. A non-regulated 12VDC power supply is usually 16 V at the peak. Average ionization voltage is around 5000VDC. The magnification is about 420 times. A non-regulated 12 VDC power supply voltage output will be over 6700VDC. Components used in the multiplier circuits will have to be able to compensate the increased voltage output otherwise they may fail. By the same token, the UV source 96 is also electrically rated and may fail prematurely if input voltage is increased substantially.

FIG. 8 shows 2 voltage multipliers 73 in the functional diagram. However, more than 2 voltage multipliers 73 can be applied. A synchronized supercharged electrostatic field air filtration with germicidal UV light system 22 can have more than one ionization system or more than one subcompact electrostatic field system 5. Extra ionization systems can be place remotely from the main body of the synchronized supercharged electrostatic field air filtration with germicidal UV light system 22 such that it can more efficiently cover a larger area with its ionization air cleaning processes. Extra subcompact electrostatic field system 5 can be place in parallel circuit to increase the surface area of the subcompact electrostatic field system 5 or in series such that the clean air stream leaving the first subcompact electrostatic field system 5 is re-cleaned by one or more subcompact electrostatic field system 5 to achieve the most desirable results for the user.

The UV light germicidal system 24, connected to the main control 71, is consisted of UV light control system 82, UV light source 96 and sensor 81. UV light germicidal system 24 receives power from main control 71 generates electrical function to operate UV light source 96 which in turn generates germicidal UV rays. Sensor 81 senses the output status of UV light source 96 if it is operating or not, and feeds the information back to the main control 71. Main control equipped with indication functions that will display the status of the UV light germicidal system to user. The UV light source 96 has a finite life averaging around 5,000 hours and has to be replaced when it fails.

Fan 6 receives power from main control 71, operates and drives air flow through the synchronized supercharged electrostatic field air filtration with germicidal UV light system 22.

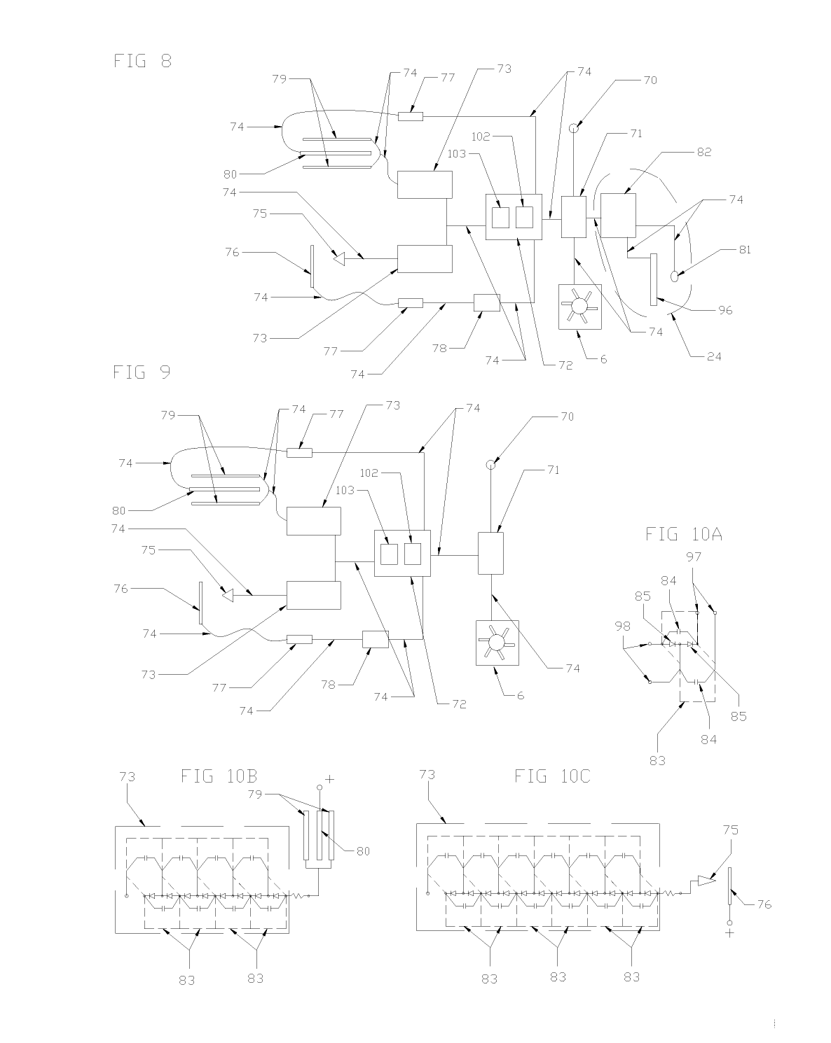

FIG. 9 is a functional diagram of a preferred embodiment of the electrical control circuit of the synchronized supercharged electrostatic field filtration system 1. Electrical connections 74 provide the conductivities among all the functions within the system. The main control 71 receives power input from power source 70. The main control 71 has electrical circuit function that receives electrical signals from various signal input devices and sends out driver functions to subsystems to perform correlated operations. The main control 71 has input voltage regulating function to provide a steady and constant voltage to the input of the high voltage converter 72. High voltage converter 72 comprises of oscillator circuit 102 and step-up transformer circuit 103. The oscillator circuit 102 converts a DC power source into a pulsating/oscillating DC power source as the input power source to at least one step-up transformer circuit 103 which in turn produces a high oscillating negative voltage output 95. This high oscillating negative voltage output 95 is sent to the input of 2 voltage multipliers 73. The first voltage multiplier 73 produces a high constant negative voltage which is then sent to the ionization needle 75 where ionization occurs. Target 76 is made of conductive material and is connected to the positive voltage supply of the main control 71 through a current flow protector 77 and a switch 78. Positively charged target 76 increases the electrical potential at the ionization needle 75 and thus increases the rate of ionization. Positively charged target 76 also influence the direction of the ionized air flow to move along a path with direction pointing from the ionization needle 75 towards the target 76. The current flow protector 77 protects the back flow of electricity collected by the target 76 from the ionized air flow to the main control 71. The switch 78 provides the option of applying electrical connection to the target 76. Positively charged target 76 helps to lower the ionization voltage requirement at the ionization needle 75.

The second voltage multiplier 73 produces a high constant negative voltage which is then sent to the negative plates 79, which is of conducting material, of the subcompact electrostatic field system 5. Positive collector 80, which is made of conductive material, of subcompact electrostatic field system 5 is connected to the positive voltage supply of the main control 71 through a current flow protector 77. The input voltage regulating function of main control 71 is very important to this preferred embodiment. For example, a 12 VDC regulated power supply has a tolerance of +/−0.3V. A non-regulated 12VDC power supply is usually 16 V at the peak. Average ionization voltage is around 5000VDC. The magnification is about 420 times. If a non-regulated 12 VDC power supply is used the voltage output will be over 6700VDC. Components in the multiplier circuits will have to be able to compensate the increased voltage output otherwise they may fail.

FIG. 9 shows 2 voltage multipliers 73 in the functional diagram. However, more than 2 voltage multipliers 73 can be applied. A synchronized supercharged electrostatic field filtration system 1 can have more than one ionization system or more than one subcompact electrostatic field system 5. Extra ionization systems can be place remotely away from the main body of the synchronized supercharged electrostatic field air filtration with germicidal UV light system 22 such that it can more efficiently covering a larger area with its ionization air cleaning processes. Extra subcompact electrostatic field system 5 can be place in parallel circuit to increase the surface area of the subcompact electrostatic field system 5 or in series such that the clean air stream leaving the first subcompact electrostatic field system 5 is re-cleaned by one or more subcompact electrostatic field system 5 to achieve the desirable results for the user.

Fan 6 receives power from main control 71, operates and drives air flow through the synchronized supercharged electrostatic field air filtration system 1.

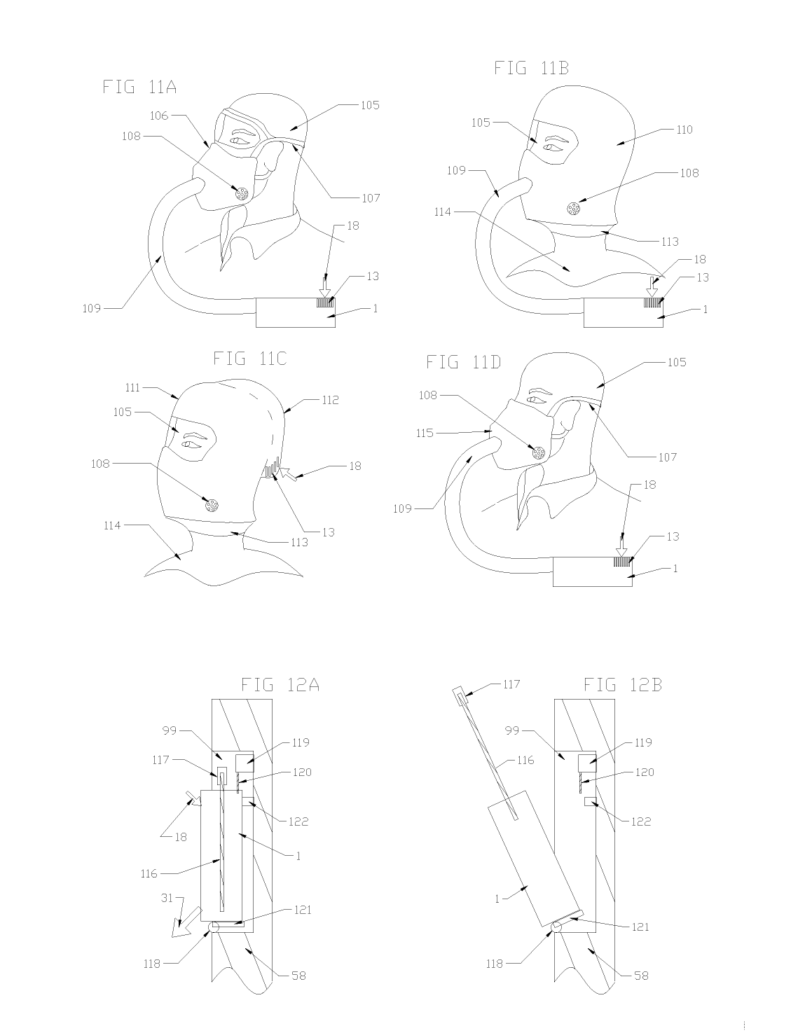

FIG. 10 illustrates one type of the multiplier circuits. FIG. 10A is a single stage multiplier cell 83. It consists of electrical components including capacitors 84 and diodes 85 but not necessarily limited to these types of component or the illustrated quantities. It has at lease one input lead 97 for receiving power input and at least one output lead 98 to provide multiplied voltage power to external devices. The output voltage is higher than the input voltage.

FIG. 10B is the voltage multiplier 73 for the subcompact electrostatic field system 5. The voltage multiplier 73 is consisted of multiple multiplier cells 83 connected together in series with the output of stage 1 multiplier cell 83 connected to the input of stage 2 multiplier cell 83. The overall magnification of the voltage multiplier 73 can easily achieve the requirement of the subcompact electrostatic field system 5. The output from the voltage multiplier 73 is then sent through a resistor to the negative plate 79 of the subcompact electrostatic field system 5.

FIG. 10C is the voltage multiplier 73 for the dual functions ionization system 4. The voltage multiplier 73 is consisted of multiple multiplier cells 83 connected together in series with the output of stage 1 multiplier cell 83 connected to the input of stage 2 multiplier cell 83. The overall magnification of the voltage multiplier 73 can easily achieve the requirement of the dual functions ionization system 4. The output form the voltage multiplier 73 is then sent through a resistor to the ionization needle 75 of the dual functions ionization system 4.

FIG. 11 illustrates the application of this new invention being adapted to a nose mask, face mask, hood and helmet. FIG. 11A shows a face mask 106 being adapted to the face of a user 105 with a strap 107 supporting the face mask 106 to the user 105. The edges of the face mask 106 is in constant contact with the face contour of user 105 providing a sealing function between the air inside the face mask 106 and the outside ambient. An air hose 109 is connected to the face mask 106 and the outlet opening of the supercharged electrostatic field air filtration system 1. This application is generic to supercharged electrostatic air filtration with germicidal UV light system 22. During operation, air flow 18 enters into the supercharged electrostatic field air filtration system 1 through the inlet opening 13. The existing clean air from supercharged electrostatic field air filtration system 1 is supplied to the face mask 106 through the air hose 109 with positive air pressure. This will result in continuous air flow from the supercharged electrostatic field air filtration system 1 and exiting through exhaust valve 108. User 105 inhales the clean air inside the face mask 106. Exhalation from user 105 will then be carried by the air stream and exhaust out through the exhaust valve 108 to the ambient.

FIG. 11B shows a hood 110 being adapted to the head of a user 105. A collar seal 113 of hood 110 is adapted to the body 114 of user 105 providing a sealing function separating the air inside the hood 110 from the ambient. An air hose 109 is connected to the hood 110 and the outlet opening of the supercharged electrostatic field air filtration system 1. This application is generic to supercharged electrostatic field air filtration with germicidal UV light system 22. During operation, air flow 18 enters into the supercharged electrostatic field air filtration system through the inlet opening 13. The existing clean air from supercharged electrostatic field air filtration system is supplied to the hood 110 through the air hose 109 with positive air pressure. This will result in continuous air flow from the supercharged electrostatic field air filtration system 1 and exiting through exhaust valve 108. User 105 inhales the clean air inside the hood 110. Exhalation from user 105 will then be carried by the air stream and exhaust out through the exhaust valve 108 to the ambient.

FIG. 11C shows a helmet 111 with built-in air filtration system 112 being adapted to the head of a user 105. This air filtration system is a supercharged electrostatic field air filtration system 1. A collar seal 113 of helmet 111 is adapted to the body 114 of user 105 providing a sealing function to separate the air inside the helmet 111 from the ambient. This application is generic to supercharged electrostatic field air filtration with germicidal UV light system. During operation, air flow 18 enters into the supercharged electrostatic field air filtration system through the inlet opening 13. The existing clean air from supercharged electrostatic field air filtration system is supplied to the inside cavity of helmet 111 with positive air pressure. This will result in continuous air flow from the supercharged electrostatic field air filtration system 1 and exiting through exhaust valve 108. User 105 inhales the clean air inside the helmet 111. Exhalation from user 105 will then be carried by the air stream and exhaust out through the exhaust valve 108 to the ambient.

FIG. 11D shows a nose mask 115 being adapted to the face of a user 105 with a strap 107 supporting the nose mask 115 to the user 105. The edges of the nose mask 115 is in constant contact with the face contour of user 105 providing a sealing function between the air inside the nose mask 115 and the outside ambient. An air hose 109 is connected to the nose mask 115 and the outlet opening of the supercharged electrostatic field air filtration system 1. This application is generic to supercharged electrostatic air filtration with germicidal UV light system. During operation, air flow 18 enters into the supercharged electrostatic field air filtration system through the inlet opening 13. The existing clean air from supercharged electrostatic field air filtration system is supplied to the face mask 106 through the air hose 109 with positive air pressure. This will result in continuous air flow from the supercharged electrostatic field air filtration system 1 and exiting through exhaust valve 108. User 105 inhales the clean air inside the nose mask 115. Exhalation from user 105 will then be carried by the air stream and exhaust out through the exhaust valve 108 to the ambient.

FIG. 12 illustrates a synchronized supercharged electrostatic field air filtration system 1 being integrated into a wall opening as stated in FIG. 7 with mechanism to allow user access to remove the particle collector plate form the system for periodic cleaning. It is generic to partition wall and ceiling. It is also generic to apply to synchronized supercharged electrostatic field air filtration with UV light germicidal system 22. FIG. 12A illustrates a synchronized supercharged electrostatic field air filtration system 1 being integrated into a wall opening during operation. A synchronized supercharged electrostatic field air filtration system 1 residing inside recess pocket 99, is mounted onto the hinge base 121 of hinge 118, which is anchored to the partition wall 58.

Synchronized supercharged electrostatic field air filtration system 1 is equipped with a removable cathode plate 15 for particle collection and requires periodic cleaning. The cathode plate 15 is equipped with a cathode plate handle 117. A latching mechanism 122 is used to secure the synchronized supercharged electrostatic field air filtration system 1 to partition wall 58. This latching mechanism 122 can be a mechanical fastener, magnetic latch or other mechanical means that can facilitate the latching function to secure the synchronized supercharged electrostatic field air filtration system 1 to partition wall 58. A locking device 119 with matching key, equipped with a lock latch 120 is used to secure the synchronized supercharged electrostatic field air filtration system 1 to the partition wall 58 such the synchronized supercharged electrostatic field air filtration systeml will only be serviced by authorized persons. This matching key can be mechanical key or electronic key or key operated by digital codes. The synchronized supercharged electrostatic field air filtration system 1 can be partially residing inside the recess pocket 99 or completely within the form factor of the thickness of the partition wall 58.

FIG. 12B illustrates a synchronized supercharged electrostatic field air filtration system 1 integrated into a wall opening and being released from the secured position for maintenance access. A synchronized supercharged electrostatic field air filtration system 1 residing inside recess pocket 99, is mounted onto the hinge base 121 of hinge 118, which is anchored to the partition wall 58. Synchronized supercharged electrostatic field air filtration system 1 is equipped with a removable cathode plate 15 for particle collection. The cathode plate 15 is equipped with a cathode plate handle 117. The latching mechanism 122 for securing the synchronized supercharged electrostatic field air filtration system 1 to partition wall 58 is released. During maintenance service, the synchronized supercharged electrostatic field air filtration system 1 swings out from the recess pocket 99 of the partition wall 58 by pivoting through the hinge 118. This allows the cathode plate 116 to be removed from the synchronized supercharged electrostatic field air filtration system 1 easily or inserted into the synchronized supercharged electrostatic field air filtration system 1 easily. The synchronized supercharged electrostatic field air filtration system 1 will be secured into the recess pocket 99 as in FIG. 12A after the maintenance service.

It will be appreciated that the sizes, quantities, shapes and dispositions of various components like needlepoint ionization pins, negative plates, positive collectors, louver, conductor leads, wires, cable length, material use, and size of the plates can be varied, without departing from the spirit and scope of the invention. Similarly, the sizes, locations, quantity and flow rate of fans, air inlet openings, air outlet openings and the like may be varied. While the layouts of the air filtering systems and air flow paths are illustrated, other methods may instead be used to facilitate the concept. While a UV source is illustrated, multiple UV source, size and power rating may be varied without departing from the spirit and scope of the invention. While the methods of mounting and integration of the system to a wall and partition concepts are illustrated, other methods may instead be used to facilitate the concept of mounting fixed surfaces.

Modifications and variations may be made to the disclosed embodiments without departing from the subject and spirit of the invention as defined by the following claims.

### INDUSTRIAL APPLICABILITY

This invention provides cost effective means to manufacture air purification systems with smaller physical form factor with much improved efficiency. The synchronized electrical circuit design greatly reduces the component cost as well as heat generation during operation.

1. A synchronized supercharge electrostatic field air filtration device is further comprised of
a housing with an inside chamber sealed from the surrounding ambient with at least one inlet opening for receiving air flow into the said chamber and at least one outlet opening for air flow leaving the said chamber to the ambient;
a dual functions ionization element located inside said chamber at said inlet opening;
an electrostatic field element located inside said chamber between the said dual functions ionization element and said outlet opening;
an electrical fan located inside said chamber provides air exchange driving functions through said housing;
a condensation collection element;
a control system consists of printed circuit board assembly and electronic components provides electronic functions to operate the said dual functions ionization element, electrostatic field element and fan.

2. The apparatus of claim 1, wherein said synchronized supercharge electrostatic air filtration device is further comprised of a UV light germicidal element located inside said chamber;

3. The apparatus of claim 1, wherein said dual functions ionization element is further comprised of
a conducting target element;
an electrical coupling means for receiving an electric potential from a high voltage source;
an ionizing element comprising an electrically conductive material having at least one needle-pointed end for providing a high potential gradient to ionize particle components of a gas passing there-through, said conducting collector element and ionizing element being connected to the electrical coupling means to produce said high potential gradient when supplied with charge from a high voltage source through said electrical coupling means.

4. The apparatus of claim 3, wherein functions of said dual functions ionization element comprise
an air cleaning function by using ionized air molecules bombarding nearby airborne matters to pass the electrical charges to said airborne matters such that the electrically charged airborne matters will attract by other non-charged airborne matters and eventually become to heavy and drop to the ground;
a supercharging of airborne matters function by using ionized air molecules bombarding airborne matters to pass electrical charges to said airborne matters such that said electrically charged airborne matters increase the electrostatic energy potential when said electrically charged airborne matters carried by an air stream passing through an electrostatic field of an electrostatic field element.

5. The apparatus of claim 3, wherein functions of said conducting target element comprise
a directional path for the ionized air molecules to flow from said needle-pointed ends towards said conducting target element;
an increase in electrical potential difference resulting in increasing rate of ionization at said needle-pointed ends;
an increase in electrical potential difference resulting in ionization at lower electrical voltage requirement.

6. The apparatus of claim 3, wherein said electrically conductive material having needle-pointed ends may be substituted with conductive metal-coated fine non-metallic filaments.

7. The apparatus of claim 1, wherein said electrostatic field element is further comprised of
an electrical coupling means for receiving an electric potential from a high negative voltage source;
at least one removable first conductor electrode, which is connected to the positively charged pole of said electrical coupling means, functions as the airborne matters collector;
at least one second conductor electrode, which is parallel to said first conductor, is connected to the negatively charged pole of the said electrical coupling means, produces an electrostatic field between said first conductor electrode and said second conductor electrode due to the production of said high potential gradient when supplied with charge from a high voltage source through said electrical coupling means.

8. The apparatus of claim 7 wherein said subcompact electrostatic field element is inclined to horizontal to decrease the maximum size of condensation water droplet forms on the surfaces of the first conductor electrode and second conductor electrode and allows the electrodes to be placed closer together resulting that said electrostatic field element becomes more compact with higher electrostatic attraction force.

9. The apparatus of claim 7 wherein said first conductor electrode has combo-hydro surface which comprised of a large portion of hydrophilic surface with small portion of hydrophobic surface.

10. The apparatus of claim 8 wherein said small portion of hydrophobic surface is a collection of fine pattern of hydrophobic surfaces spreading over the entire said hydrophilic surface.

11. The apparatus of claim 8 wherein said combo-hydro surface decreases the size of the water droplet formed by condensation on the surface of the first conductor electrode and the surface of the second conductor electrode while providing optimized surface area for said electrostatic field element to operate, and allows the electrodes to be placed closer together resulting that said electrostatic field element becomes more compact with higher electrostatic attraction force.

12. The apparatus of claim 7 wherein at surface of said first conductor electrode having polished surface, reduces the maximum size of water condensation droplet can be formed on said surface.

13. The apparatus of claim 7 wherein surface of said second conductor electrode having polished surface, reduces the maximum size of water condensation droplet can be formed on said surface.

14. The apparatus of claim 1 wherein said housing provides mechanical means to allow said synchronized supercharge electrostatic air filtration device to be mounted to an office partition.

15. The apparatus of claim 1 wherein said printed circuit board assembly is further comprised of
at least one oscillator circuit to convert a DC power source into a pulsating/oscillating DC power source as the input power source to at least one step-up transformer circuit of a high voltage power supply source;
said step-up transformer with at least one primary winding and at least one secondary winding to transform said pulsating/oscillating DC power source input to an ultra high voltage at its output;
at least one voltage multiplier circuit, supplying power to said dual functions ionization element, to receive said ultra high voltage and multiply said ultra high voltage to a voltage that can support effective ionization at said dual functions ionization element;
at least one voltage multiplier circuit, supplying power to said subcompact electrostatic field element, to receive said ultra high voltage and multiply said ultra high voltage to a voltage that can support effective electrostatic field generation at the said electrostatic field element.

16. The apparatus of claim 15, wherein said voltage multiplier circuit supplying power to said dual ionization element and said voltage multiplier circuit supplying power to said electrostatic field element are made up of similar multiplier cell circuits with at least one capacitor and at least one diode in said multiplier cell circuit.

17. The apparatus of claim 15, wherein said printed circuit board assembly is further comprised of a driver circuit to provide electrical power function to operate said UV light germicidal element.

18. The apparatus of claim 2, wherein said UV light germicidal element is further comprised of
an inlet louver allowing air to pass through but confining UV ray to escape;
a UV light chamber
a germicidal UV source to generate germicidal UV light when power is applied to it;
a reflection surface to increase the efficiency of the UV light system;
an outlet louver allowing air to pass through but confining UV ray to escape.

19. The apparatus of claim 18, wherein said inlet louver by adding turbulence to an air stream, reduces air stagnation spots within said UV light chamber and increases said air stream traveling time within the said UV chamber.

20. The apparatus of claim 18, wherein said inlet louver by adding turbulence to an air stream, increases said air stream traveling time within said UV light chamber such that said air stream will be subjected to longer duration under said germicidal UV light exposure.

21. The apparatus of claim 18, wherein said outlet louver by adding turbulence to an air stream, decreases the speed of said air stream when leaving said UV light chamber such said air stream will be subjected to longer electrostatic field filtration process when it enters into an electrostatic field air filtration apparatus.

22. The apparatus of claim 1, wherein said synchronized supercharge electrostatic field air filtration device is incorporated into a face mask, adapted to be carried on a human body, provides filtered air into said face mask.

23. The apparatus of claim 1, wherein said synchronized supercharge electrostatic field air filtration device is incorporated into a nose mask, adapted to be carried on a human body, provides filtered air into said face mask.

24. The apparatus of claim 1, wherein said synchronized supercharge electrostatic field air filtration device is incorporated into a hood, adapted to be carried on a human body, provides filtered air into the inside chamber of said hood.

25. The apparatus of claim 1, wherein said synchronized supercharge electrostatic field air filtration device is incorporated into a helmet, adapted to be carried on a human body, provides filtered air into the inside chamber of said helmet.

26. The method of filtering air in an environment by integration a synchronized supercharge electrostatic field air filtration device of claim 1 to a wall.

27. The apparatus of claim 26 wherein said wall includes internal wall, ceiling and panel of building; internal wall, ceiling and panel of automobile; internal wall, ceiling and panel of ship; internal wall, ceiling and panel of airplane.

28. The apparatus of claim 26 wherein said wall is an office partition.

29. The apparatus of claim 26 wherein said integration is by mounting said synchronized supercharge electrostatic field air filtration device onto the surface of a wall by mechanical means.

30. The apparatus of claim 26 wherein said integration is by mounting said synchronized supercharge electrostatic field air filtration device into a wall with at least portion of said synchronized supercharges electrostatic field air filtration device resides inside a recess pocket of a wall.

31. The apparatus of claim 26 wherein said integration is by mounting said synchronized supercharged electrostatic field air filtration device into a wall with said synchronized supercharge electrostatic air filtration device resides inside a recess pocket within the form factor of a wall.

32. The apparatus of claim 26 wherein said synchronized supercharge electrostatic field air filtration device is with UV light germicidal function.

33. The apparatus of claim 30 wherein said integration includes mechanical means to secure said synchronized supercharged electrostatic field air filtration device inside said recess pocket.

34. The apparatus of claim 33 wherein said mechanical means include a magnetic latch.

35. The apparatus of claim 30 wherein said integration includes locking mechanism with matching key, to secure said synchronized supercharged electrostatic field air filtration device inside said recess pocket.

36. The apparatus of claim 35 wherein said matching key is an electronic key.

37. The apparatus of claim 35 wherein said matching key is a mechanical key.

38. The apparatus of claim 35 wherein said matching key is operated by digital code.

39. The apparatus of claim 30 wherein said integration includes hinge to allow said synchronized supercharged electrostatic field air filtration device be swung out from said recess pocket for easy maintenance access.

40. The method of filtering air in an environment by integration an ionization air filtration device into a wall with at least portion of said ionization air filtration device resides inside a recess pocket of a wall.

41. The apparatus of claim 40 wherein said wall includes internal wall, ceiling and panel of building, internal wall, ceiling and panel of automobile, internal wall, ceiling and panel of ship, internal wall, ceiling and panel of airplane.

42. The apparatus of claim 40 wherein said wall is an office partition.

43. The apparatus of claim 40 wherein said ionization air filtration device is with UV light germicidal function.

44. The apparatus of claim 40 wherein said integration is by mounting said ionization air filtration device into a wall with said ionization air filtration device resides inside a recess pocket within the form factor of a wall.
